(19) United States
(12) Patent Application Publication
(10) Pub. No.: US 2024/0100856 A1
(43) Pub. Date: Mar. 28, 2024

(54) IMAGE FORMING APPARATUS

(71) Applicant: KYOCERA Document Solutions Inc., Osaka-shi (JP)

(72) Inventors: Hiroomi Nakatsuji, Osaka (JP); Jun Nakano, Osaka (JP); Naoko Kawashima, Osaka (JP); Masato Usui, Osaka (JP)

(21) Appl. No.: 18/469,481

(22) Filed: Sep. 18, 2023

(30) Foreign Application Priority Data
Sep. 22, 2022 (JP) 2022-151917

(51) Int. Cl. B41J 2/21; B41J 29/393

(52) U.S. Cl. CPC B41J 2/2142; B41J 2/2139; B41J 29/393; B41J 2029/3935

(57) ABSTRACT

An abnormal ejection detection portion detects an abnormal ejection nozzle in a print head based on a read test image read from a sheet with a test pattern formed thereon. When a plurality of abnormal ejection nozzles are detected and the plurality of abnormal ejection nozzles include two consecutive abnormal nozzles corresponding to two consecutive pixels in the read test image, a correction processing portion performs increase correction on an ink ejection amount of consecutive adjacent nozzles adjacent to the two consecutive abnormal nozzles and performs decrease correction on an ink ejection amount of secondary adjacent nozzles adjacent to the consecutive adjacent nozzles.

### INCORPORATION BY REFERENCE

This application is based upon and claims the benefit of priority from the corresponding Japanese Patent Application No. 2022-151917 filed on Sep. 22, 2022, the entire contents of which are incorporated herein by reference.

### BACKGROUND

The present disclosure relates to an image forming apparatus.

An inkjet image forming apparatuses prints a test pattern with a print head and detects an abnormal ejection nozzle based on the printed test pattern image. The abnormal ejection nozzle is a part of the nozzles for ejecting ink in the print head that can no longer eject ink normally.

For example, the image forming apparatus increases the ejection amount of adjacent dots based on the occurrence status of abnormal ejection nozzles.

### SUMMARY

An image forming apparatus according to the present disclosure includes a sheet conveying portion, a print head, a control portion, an abnormal ejection detection portion, and a correction processing portion. The sheet conveying portion conveys a sheet. The print head includes a plurality of nozzles for forming an image on the conveyed sheet by ejecting ink onto the sheet. The control portion causes the sheet conveying portion and the print head to execute processing for forming a test pattern on the sheet. The abnormal ejection detection portion detects an abnormal ejection nozzle in the print head based on a read test image read from the sheet with the test pattern formed thereon. The correction processing portion corrects an ink ejection amount of a part of the plurality of nozzles corresponding to the abnormal ejection nozzle. When a plurality of abnormal ejection nozzles are detected and the plurality of abnormal ejection nozzles include two consecutive abnormal nozzles corresponding to two consecutive pixels in the read test image, the correction processing portion performs increase correction on an ink ejection amount of consecutive adjacent nozzles adjacent to the two consecutive abnormal nozzles and performs decrease correction on an ink ejection amount of secondary adjacent nozzles adjacent to the consecutive adjacent nozzles.

This Summary is provided to introduce a selection of concepts in a simplified form that are further described below in the Detailed Description with reference where appropriate to the accompanying drawings. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

### BRIEF DESCRIPTION OF THE DRAWINGS

FIG. 1 is a diagram showing a mechanical internal configuration of an image forming apparatus according to an embodiment of the present disclosure.

FIG. 2 is a plan view showing an example of print heads in the image forming apparatus shown in FIG. 1.

FIG. 3 is a block diagram showing an electrical configuration of the image forming apparatus 10 according to the embodiment of the present disclosure.

FIG. 4 is a diagram illustrating a test pattern printed in the image forming apparatus shown in FIG. 1 to FIG. 3.

FIG. 5 is a diagram showing an example read image of a test pattern in a case where two nozzles corresponding to two consecutive pixels are abnormal ejection nozzles.

FIG. 6 is a diagram illustrating correction of the ink ejection amount of secondary adjacent nozzles.

FIG. 7 is a diagram showing an example of test patterns printed before and after correction processing in a case where an ejection abnormality occurs in two consecutive nozzles.

### DETAILED DESCRIPTION

Hereinafter, an embodiment of the present disclosure will be described with reference to the drawings.

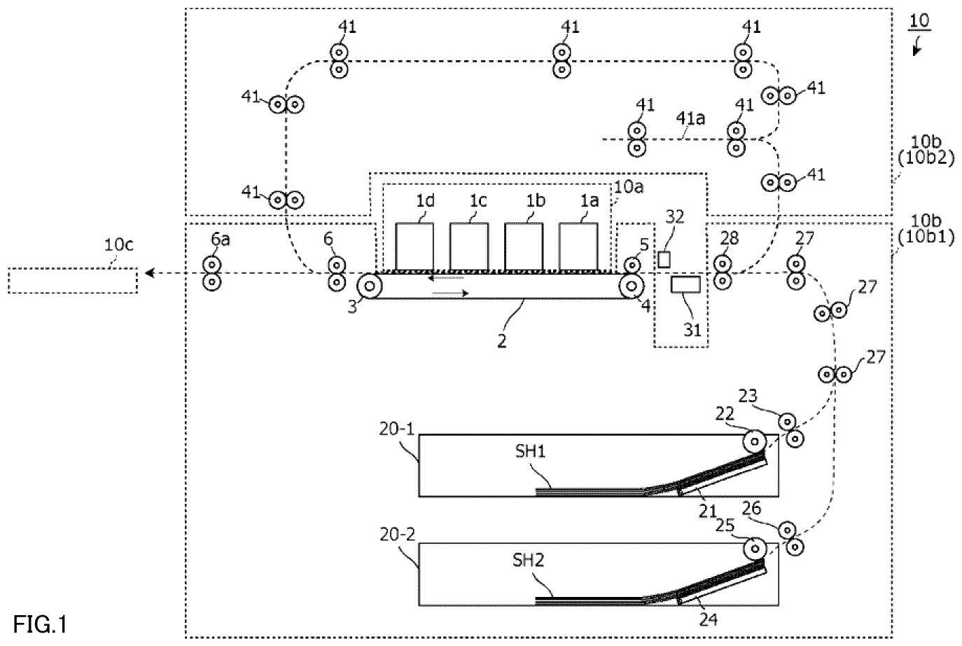

FIG. 1 is a side view illustrating a mechanical internal configuration of an image forming apparatus according to an embodiment of the present disclosure. An image forming apparatus 10 according to this embodiment is a printer, a copier, a facsimile machine, or a multifunction peripheral.

The image forming apparatus 10 shown in FIG. 1 includes a print engine 10a and a sheet conveying portion 10b. The print engine 10a physically forms, on a print sheet, a page image to be printed. In this embodiment, the print engine 10a is a line-type inkjet print engine.

In this embodiment, the print engine 10a includes line-type print heads 1a to 1d corresponding to four ink colors of cyan, magenta, yellow, and black.

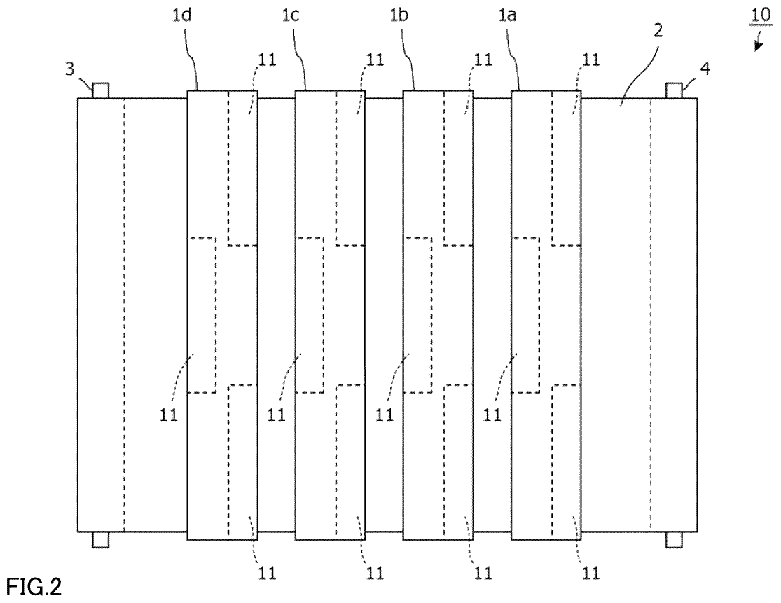

FIG. 2 is a plan view showing an example of the print heads 1a, 1b, 1c, and 1d in the image forming apparatus 10 shown in FIG. 1.

For example, as shown in FIG. 2, in this embodiment, the print heads 1a, 1b, 1c, and 1d each have a plurality (here, three) of head portions 11. In the present embodiment, the print heads 1a, 1b, 1c, and 1d each have three head portions 11. These head portions 11 are arranged along a main scanning direction, and can be attached to and detached from the apparatus main body.

It is noted that each of the print heads 1a, 1b, 1c, and 1d may have one head portion 11. The head portion 11 of each of the print heads 1a, 1 b, 1c, and 1d includes a plurality of nozzles two-dimensionally arranged corresponding to a plurality of ejection positions in the main scanning direction. The head portion 11 ejects ink corresponding to an image to be printed from the plurality of nozzles by operating piezoelectric elements in the respective nozzles.

The sheet conveying portion 10b conveys the print sheet before printing to the print engine 10a along a predetermined conveying path. Further, the sheet conveying portion 10b conveys the print sheet after printing from the print engine 10a to a predetermined discharge destination such as a discharge tray 10c.

The sheet conveying portion 10b includes a main sheet conveying portion 10b1 and a circulating sheet conveying portion 10b2. When double-sided printing is performed, the main sheet conveying portion 10b1 conveys the print sheet before printing to the print engine 10a. Further, the circulating sheet conveying portion 10b2 conveys the print sheet from the subsequent stage to the preceding stage of the print engine 10a while retaining a predetermined number of print sheets with a page image printed on their first surfaces.

In the present embodiment, the main sheet conveying portion 10b1 includes an annular conveying belt 2, a drive roller 3, a driven roller 4, a suction roller 5, and a discharge roller pair 6, 6a. The conveying belt 2 is suspended on the drive roller 3 and the driven roller 4. The drive roller 3 and the driven roller 4 cause the conveying belt 2 to go around.

The conveying belt 2 is arranged to face the print engine 10a and conveys the print sheet. The suction roller 5 sandwiches the print sheet between itself and the conveying belt 2.

The suction roller 5 sandwiches the print sheet conveyed from a sheet feed cassette 20-1, 20-2 to be described later between itself and the conveying belt 2. The print sheets are sequentially conveyed from the position of the suction roller 5 to a print position facing the print heads 1a to 1d by the conveying belt 2.

The print sheet is printed with a multi-color image by the print heads 1a to 1d at the print position. The color-printed print sheet is discharged to the discharge tray 10c or the like by the discharge roller pair 6, 6a.

The main sheet conveying portion 10b1 further includes a plurality of sheet feed cassettes 20-1, 20-2. The sheet feed cassettes 20-1, 20-2 contain print sheets SH1, SH2.

In each of the sheet feed cassettes 20-1, 20-2, a lift plate 21, 24 pushes up the print sheets SH1, SH2, thereby bringing the print sheets SH1, SH2 into contact with a pickup roller 22, 25. The pickup roller 22, 25 picks up the print sheets SH1, SH2 loaded in the sheet feed cassette 20-1, 20-2 one by one from the top to a sheet feed roller 23, 26.

The sheet feed roller 23, 26 conveys the print sheets SH1, SH2 picked up from the sheet feed cassette 20-1, 20-2 to the conveying path one by one. The conveying roller 27 conveys, along the conveying path, the print sheets SH1, SH2 conveyed from the sheet feed cassette 20-1, 20-2.

When double-sided printing is performed, the circulating sheet conveying portion 10b2 returns the print sheet from a predetermined position downstream of the print engine 10a to a predetermined position upstream thereof. In the present embodiment, the circulating sheet conveying portion 10b2 returns the print sheet to a position upstream of a line sensor 31 to be described later.

The circulating sheet conveying portion 10b2 includes a conveying roller 41 and a switchback conveying path 41a. In order to switch the surface of the print sheet facing the print engine 10a from the first surface to the second surface, the traveling direction of the print sheet is reversed in the switchback conveying path 41a.

The image forming apparatus 10 further includes a line sensor 31 and a sheet detection sensor 32.

The line sensor 31 is disposed along a direction orthogonal to the conveying direction of the print sheet. The line sensor 31 is an optical sensor that detects the positions of both edges of the print sheet. The positions of both edges are the positions of the both sides of the print sheet.

For example, the line sensor 31 is a contact image sensor (CIS). In this embodiment, the line sensor 31 is disposed between a registration roller 28 and the print engine 10a.

The sheet detection sensor 32 is an optical sensor that detects that the leading end of a print sheet SH1, SH2 has passed a predetermined position on the conveying path. When the leading end of the print sheet SH1, SH2 is detected by the sheet detection sensor 32, the line sensor 31 detects the positions of both edges of the print sheet.

The print engine 10a is disposed on either the upper side or the lower side of the conveying path. In the example shown in FIG. 1, the print engine 10a is disposed on the upper side of the conveying path of the print sheet.

On the other hand, the line sensor 31 is disposed on the other side of the upper side and the lower side of the conveying path. In the example shown in FIG. 1, the line sensor 31 is disposed on the lower side of the conveying path.

The circulating sheet conveying portion 10b2 conveys the print sheet from downstream of the print engine 10a in the conveying direction to upstream of the line sensor 31 in the conveying direction, and switches back the print sheet during the conveyance.

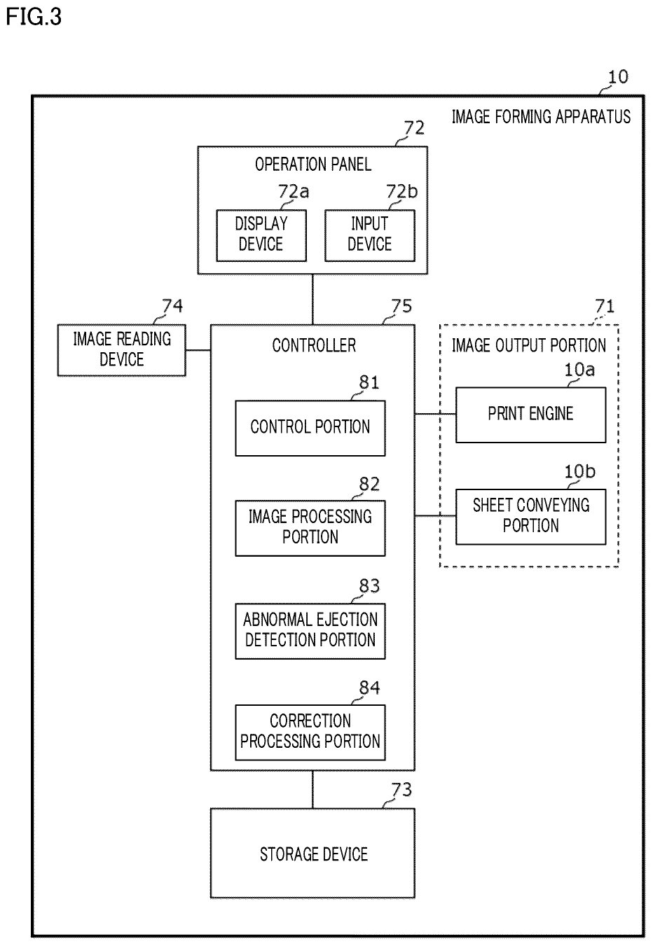

FIG. 3 is a block diagram showing an electrical configuration of the image forming apparatus 10 according to the embodiment of the present disclosure. As shown in FIG. 3, the image forming apparatus 10 includes an image output portion 71 having a mechanical configuration as shown in FIG. 1 and FIG. 2, and further includes an operation panel 72, a storage device 73, an image reading device 74, and a controller 75.

The operation panel 72 is disposed on the housing surface of the image forming apparatus 10. The operation panel 72 includes a display device 72a such as a liquid crystal display and an input device 72b such as hard keys or a touch panel. The display device 72a displays various messages to the user, and the input device 72b receives user's operations.

The storage device 73 is a nonvolatile storage device that stores data, programs, and the like necessary for controlling the image forming apparatus 10. For example, the storage device 73 is a flash memory, a hard disk drive, or the like.

The image reading device 74 includes a platen glass and an automatic document sheet feeder. The image reading device 74 optically reads an image of a document sheet placed on the platen glass or a document sheet conveyed by the automatic document sheet feeder. In addition, the image reading device 74 generates image data of the read image.

The controller 75 includes a computer that executes software processing in accordance with a program, an application specific integrated circuit (ASIC) that executes predetermined hardware processing, and the like. The controller 75 operates as various processing portions.

The computer includes a central processing unit (CPU), a read only memory (ROM), a random access memory (RAM), and the like. The CPU loads the programs stored in the ROM, the storage device 73, or the like into the RAM and executes the programs.

The CPU functions as various processing portions by executing the programs. The CPU operates as various processing portions together with the ASIC as needed. In the present embodiment, the controller 75 operates as a control portion 81, an image processing portion 82, an abnormal ejection detection portion 83, and a correction processing portion 84.

The control portion 81 controls the image output portion 71 to execute a print job requested by the user. The image output portion 71 includes the print engine 10a, the sheet conveying portion 10b, and the like.

In the present embodiment, the control portion 81 causes the image processing portion 82 to execute predetermined image processing and controls the print engine 10a. The control portion 81 causes the head portion 11 of the print engine 10a to eject ink. The control portion 81 thereby causes the print engine 10a to execute processing for forming a print image on the print sheet.

The image processing portion 82 executes various types of image processing on image data representing an image to be printed on the print sheet. For example, the image processing includes raster image processing (RIP), color conversion, halftoning, and the like.

Specifically, the control portion 81 causes the print engine 10a and the sheet conveying portion 10b to execute processing for printing a user document sheet image, which is an image based on print image data designated by the user.

In this embodiment, the control portion 81 also executes center identification processing and automatic centering processing.

The center identification processing is processing for identifying the center position of the print sheet as a sheet center actual position, based on the positions of both edges detected by the line sensor 31.

The automatic centering processing is processing for adjusting a center position of an image to be printed, based on the sheet center actual position. The control portion 81 executes the automatic centering processing as hardware processing.

Specifically, in the automatic centering processing, the control portion 81 changes the drawing position of the image to be printed by a position difference along the main scanning direction. The position difference is a difference between a reference center position of the print engine 10a and the sheet center actual position.

In the present embodiment, the plurality of nozzles do not move. Therefore, the control portion 81 changes the nozzle that ejects ink corresponding to each pixel in the image to be printed, in accordance with the positional difference.

As described above, the control portion 81 selects one or more ejection nozzles corresponding to each pixel of the image to be printed from the plurality of nozzles of the print heads 1a to 1 d in accordance with the position of the print sheet, and causes the print heads 1a to 1d to execute the processing for ejecting ink from the ejection nozzles.

An abnormal ejection nozzle may occur in the print heads 1a to 1d. The abnormal ejection nozzle is a part of the plurality of nozzles of the heads 1a to 1d that can no longer eject ink normally.

The abnormal ejection nozzle often occurs in an isolated manner. However, the abnormal ejection nozzle may occur in two consecutive nozzles.

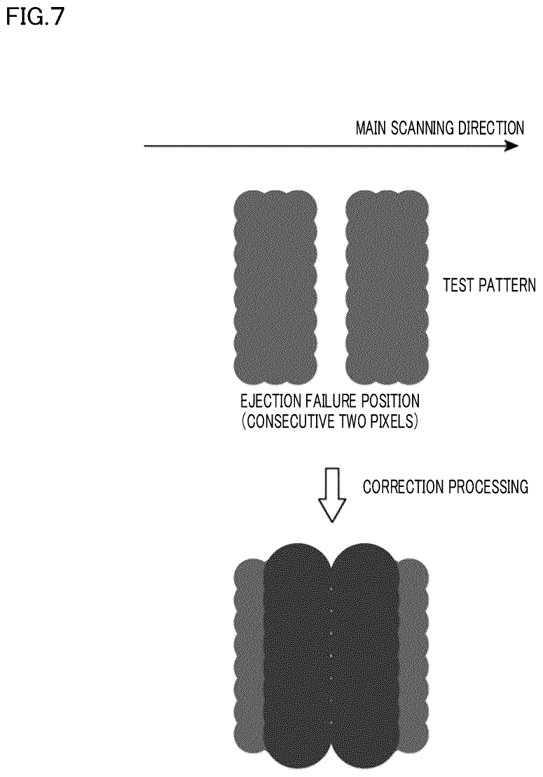

FIG. 7 is a diagram showing an example test pattern printed when an ejection abnormality occurs in two consecutive nozzles.

For example, as shown in FIG. 7, when an ejection abnormality occurs in two consecutive nozzles, the density deficient portion becomes wider than when an ejection abnormality occurs in a single nozzle. Therefore, increase correction is performed on the ink ejection amount of ink ejected from adjacent nozzles adjacent to the abnormal ejection nozzles. As a result, the ink dots corrected to increase the dot diameters cover the area of the density deficient portion.

When an ejection abnormality occurs in two consecutive nozzles, the corrected ink ejection amount is larger than when an ejection abnormality occurs in a single nozzle. Therefore, for example, as shown in FIG. 7, a black streak along a sub-scanning direction may be caused, and the print image quality may deteriorate. It is noted that the sub-scanning direction is orthogonal to the main scanning direction.

An object of the present disclosure is to suppress deterioration of print image quality when an ejection abnormality occurs in two consecutive nozzles.

The control portion 81 causes the print engine 10a and the sheet conveying portion 10b to execute processing for forming a predetermined test pattern on the print sheet. The abnormal ejection detection portion 83 identifies the abnormal ejection nozzle based on a read test image which is a read image of the test pattern.

In this embodiment, the line sensor 31 for detecting the position of the print sheet is provided. For example, the print sheet with the test pattern printed thereon is conveyed by the circulating sheet conveying portion 10b2.

Further, the line sensor 31 reads the image of the test pattern from the print sheet. The abnormal ejection detection portion 83 detects an ejection failure position based on the density distribution in the main scanning direction in the read test image obtained by the line sensor 31. Further, the abnormal ejection detection portion 83 identifies a part of the plurality of nozzles corresponding to the ejection failure position as the abnormal ejection nozzle.

It is noted that the read test image is acquired by the line sensor 31 or the image reading device 74.

When the read test image is acquired by the line sensor 31, conveyance of the print sheet with the test pattern printed thereon and reading of the read test image are automatically executed, and detection of the abnormal ejection nozzle is automatically executed by the abnormal ejection detection portion 83.

Alternatively, after the print sheet with the test pattern printed thereon is discharged, the print sheet may be set in the image reading device 74 by the user, and the image reading device 74 may read the image on the print sheet.

In addition, the control portion 81 uses the above-mentioned four ink colors as target ink colors and causes the print heads 1a to 1d to print the test pattern for the respective target ink colors. The control portion 81 controls the printing of the test pattern in accordance with a command from the abnormal ejection detection portion 83.

The abnormal ejection detection portion 83 acquires data of the read test image read from the print sheet, and detects the abnormal ejection nozzle based on the read test image. For example, the data of the read test image is RGB image data or the like.

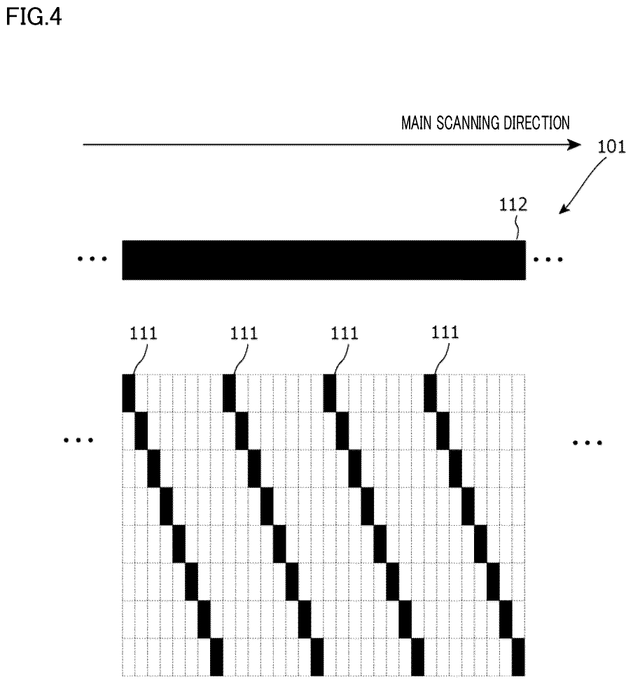

FIG. 4 is a diagram illustrating the test pattern printed by the image forming apparatus 10 shown in FIG. 1 to FIG. 3.

For example, as shown in FIG. 4, the control portion 81 causes the print heads 1a to 1d to execute processing for printing test patterns 101 of the target ink colors, each including a vertical fine line 111 and a horizontal band 112 along the main scanning direction. For example, the vertical fine line 111 is a one-dot fine line.

The abnormal ejection detection portion 83 detects the position of the density deficient portion in the vertical fine line 111 and the horizontal band 112 as the ejection failure position. Further, the abnormal ejection detection portion 83 identifies, as the abnormal ejection nozzle, one or more of the plurality of nozzles corresponding to the ejection failure position.

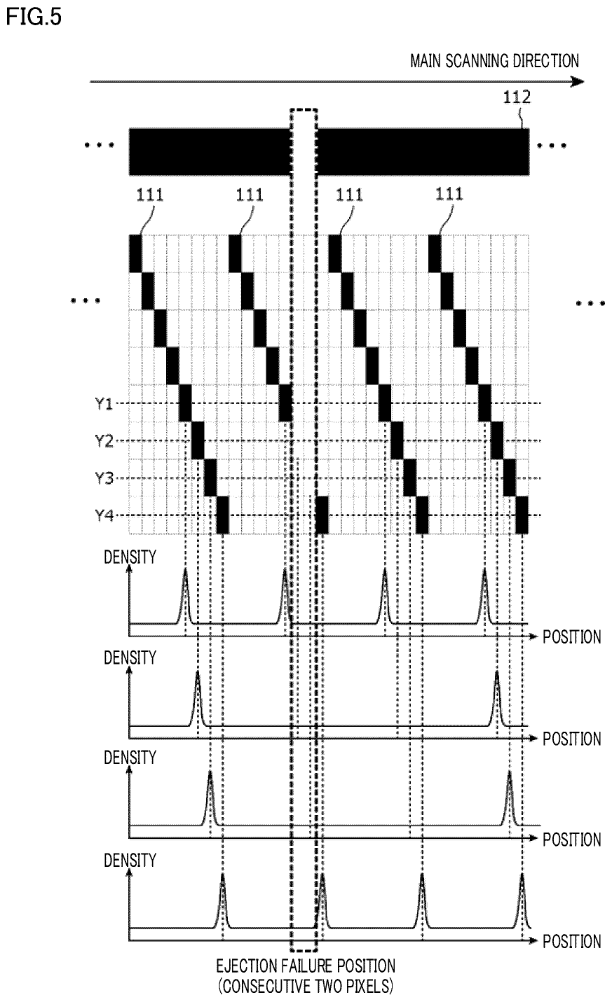

FIG. 5 shows an example of the read test image in a case where two nozzles corresponding to two consecutive pixels among the plurality of nozzles are the abnormal ejection nozzles. In the following description, the two abnormal ejection nozzles corresponding to two consecutive pixels are each referred to as a consecutive abnormal nozzle.

For example, as shown in FIG. 5, when two consecutive abnormal nozzles occur, a density deficient portion occurs in the vertical fine line 111 and the horizontal band 112. Here, each of the consecutive abnormal nozzles is a nozzle that cannot eject ink at all.

In FIG. 5, at positions Y1 and Y4 in the sub-scanning direction, there is no density deficient portion in the vertical fine line 111. On the other hand, at positions Y2 and Y3 in the sub-scanning direction, there is a density deficient portion in the vertical fine line 111. In this case, among the plurality of nozzles, two nozzles corresponding to the pixels at the positions Y2 and Y3 in the sub-scanning direction in the vertical fine line 111 are detected as the consecutive abnormal nozzles.

In the following description, among the plurality of nozzles, nozzles corresponding to pixels adjacent in the main scanning direction to the pixel corresponding to the abnormal ejection nozzle will be referred to as adjacent nozzles. That is, the adjacent nozzles are nozzles corresponding to pixels adjacent to the pixel at the ejection failure position among the plurality of nozzles. In addition, the adjacent nozzles corresponding to the consecutive abnormal nozzles will be referred to as consecutive adjacent nozzles.

The correction processing portion 84 adjusts the ink ejection amount of the adjacent nozzles corresponding to the detected abnormal ejection nozzle.

In this embodiment, the correction processing portion 84 executes, as hardware processing, correction processing corresponding to each abnormal ejection nozzle detected as described above in the image to be printed. For example, the correction processing portion 84 corrects the pixel value of the ejection failure position to a value representing non-ejection, and corrects the pixel values of the pixels adjacent to the ejection failure position in the direction of increasing pixel density.

In the following description, among the plurality of nozzles, two nozzles corresponding to the two pixels adjacent to the pixels corresponding to the consecutive adjacent nozzles on the opposite sides of the ejection failure position will be referred to as secondary adjacent nozzles.

Specifically, when two consecutive abnormal nozzles are detected, the correction processing portion 84 performs increase correction on the ink ejection amount of the consecutive adjacent nozzles, and performs decrease correction on the ink ejection amount of the secondary adjacent nozzles.

In this embodiment, the correction processing portion 84 determines whether or not to perform decrease correction on the ink ejection amount of the secondary adjacent nozzles in accordance with whether or not a correction condition based on the ink ejection amount after the increase correction of the consecutive adjacent nozzles and the ink ejection amount before the correction of the secondary adjacent nozzles is satisfied.

For example, the correction processing portion 84 individually determines whether or not to perform decrease correction on the ink ejection amount for each of the two secondary adjacent nozzles.

In the case where the consecutive abnormal nozzles are detected, when it is determined that the correction condition is satisfied, the correction processing portion 84 performs increase correction on the ink ejection amount of the consecutive adjacent nozzles and performs decrease correction on the ink ejection amount of the secondary adjacent nozzles.

On the other hand, when it is determined that the correction condition is not satisfied, the correction processing portion 84 performs increase correction on the ink ejection amount of the consecutive adjacent nozzles, but does not correct the ink ejection amount of the secondary adjacent nozzles.

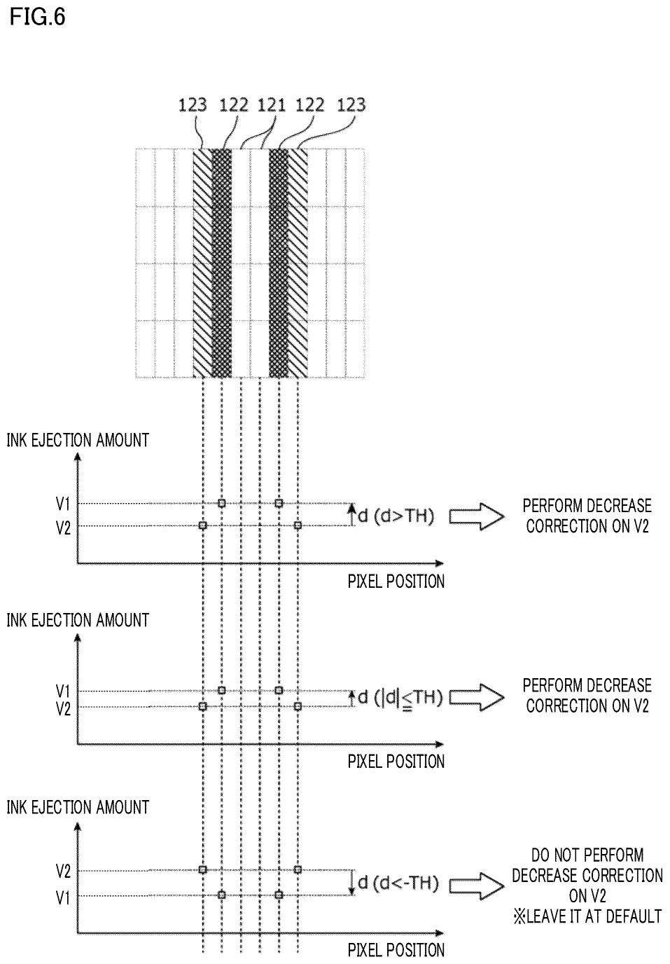

FIG. 6 is a diagram illustrating the correction of the ink ejection amount of the secondary adjacent nozzles. In FIG. 6, a first ink ejection amount V1 is the ink ejection amount after increase correction of consecutive adjacent nozzles corresponding to adjacent pixels 122 adjacent to an ejection failure pixel 121. A second ink ejection amount V2 is the ink ejection amount before correction of secondary adjacent nozzles corresponding to secondary adjacent pixels 123 adjacent to the adjacent pixels 122.

For example, as shown in FIG. 6, the correction condition includes a first correction condition that the difference d between the first ink ejection amount V1 and the second ink ejection amount V2 exceeds a predetermined threshold value TH larger than 0. Note that d=V1−V2. When the first correction condition is satisfied, the correction processing portion 84 performs decrease correction on the ink ejection amount of the secondary adjacent nozzles. The correction amount may be a predetermined amount or may be set in accordance with the difference d.

In addition, the correction condition may include a second correction condition that the absolute value of the difference d is equal to or less than the threshold value TH. When the second correction condition is satisfied, the correction processing portion 84 performs decrease correction on the ink ejection amount of the secondary adjacent nozzles in the same manner as when the first correction condition is satisfied.

On the other hand, when the difference d is less than −TH, the correction condition is not satisfied. When the correction condition is not satisfied, the correction processing portion 84 does not correct the ink ejection amount of the secondary adjacent nozzles. In this case, the correction processing portion 84 sets the ink ejection amount of the secondary adjacent nozzles to a default ink ejection amount.

In the following description, when the pixel at the ejection failure position is an isolated pixel in the read test image, the abnormal ejection nozzle corresponding to the isolated pixel at the ejection failure position will be referred to as an isolated abnormal nozzle. The adjacent nozzles corresponding to the isolated abnormal nozzle will be referred to as isolated adjacent nozzles. That is, the isolated adjacent nozzles are nozzles corresponding to the pixels adjacent to the isolated pixel at the ejection failure position in the read test image among the plurality of nozzles.

In this embodiment, when the isolated abnormal nozzle is detected, the correction processing portion 84 performs increase correction on the ink ejection amount of the isolated adjacent nozzles. In this case, the correction processing portion 84 performs increase correction on the ink ejection amount of the isolated adjacent nozzles by an amount smaller than the correction amount of the ink ejection amount of the consecutive adjacent nozzles. In other words, the correction processing portion 84 performs increase correction on the ink ejection amount of the consecutive adjacent nozzles by an amount larger than the correction amount of the ink ejection amount of the isolated adjacent nozzles.

For example, the correction processing portion 84 sets the correction amount of the ink ejection amount of the isolated adjacent nozzles in accordance with the density of the pixel at the ejection failure position corresponding to the isolated abnormal nozzle.

Next, an operation of the image forming apparatus 10 will be described.

(a) Detection of Abnormal Ejection Nozzle

The control portion 81 causes the image output portion 71 to print the test pattern 101 including the horizontal band 112 and the vertical fine line 111 on the print sheet. The abnormal ejection detection portion 83 acquires data of the read test image, which is an image of the test pattern 101 obtained by the line sensor 31 or the image reading device 74.

As described above, the abnormal ejection detection portion 83 then identifies the density distribution in the main scanning direction of each of the vertical fine line 111 and the horizontal band 112 in the read test image of the test pattern 101 for each of the target ink colors.

Further, the abnormal ejection detection portion 83 identifies the ejection failure position, which is the position of the density deficient portion, based on the identified density distribution, and identifies the nozzle corresponding to the ejection failure position as the abnormal ejection nozzle. The abnormal ejection nozzle to be subjected to the correction processing is detected in the above-described manner.

The correction processing portion 84 then determines whether each of abnormal ejection nozzle is the isolated abnormal nozzle or the consecutive abnormal nozzle. When the isolated abnormal nozzle is detected, the correction processing portion 84 sets a correction amount Vi1 in accordance with the ink ejection amount of the isolated abnormal nozzle, and increases the ink ejection amount of the isolated adjacent nozzles by the correction amount Vi1.

When the consecutive abnormal nozzles are detected, the correction processing portion 84 sets a correction amount Vi2 in accordance with the ink ejection amounts of the consecutive abnormal nozzles, and increases the ink ejection amounts of the consecutive adjacent nozzles by the correction amount Vi2. For example, Vi2>Vi1.

Further, the correction processing portion 84 performs decrease correction on the ink ejection amounts of the consecutive adjacent nozzles in accordance with the ink ejection amounts after the increase correction of the consecutive abnormal nozzles.

Information on the abnormal ejection nozzle, the adjacent nozzles, and the secondary adjacent nozzles and the ink ejection amount of each nozzle after the correction processing is performed are stored in the storage device 73 as setting data.

(b) Operation During Printing

When the control portion 81 receives a print request, the image processing portion 82 executes image processing on the image designated by the print request. The control portion 81 acquires image data of the user document sheet image obtained by the image processing.

Further, the control portion 81 causes the image output portion 71 to execute processing for printing, on the print sheet, the image to be printed, based on the image data.

The correction processing portion 84 reads the setting data from the storage device 73 before printing is started. Further, the correction processing portion 84 identifies the abnormal ejection nozzle based on the setting data, and sets a corrected ink ejection amount or correction amount for each of the abnormal ejection nozzle, the adjacent nozzles, and the secondary adjacent nozzles.

When the position of the print sheet is detected by the line sensor 31, the correction processing portion 84 identifies a target nozzle corresponding to each pixel of the user document sheet image. Further, the correction processing portion 84 executes correction processing on pixels corresponding to the abnormal ejection nozzle, the adjacent nozzles, and the secondary adjacent nozzles in the image data of the user document sheet image, based on the setting data. Then, the control portion 81 causes the image output portion 71 to execute printing based on the image data after the correction processing.

According to the above-described embodiment, the control portion 81 causes the sheet conveying portion 10b and the print heads 1a to 1d to execute processing for forming the test pattern on the print sheet. The abnormal ejection detection portion 83 detects the abnormal ejection nozzle in the print heads 1a to 1d based on the read test image read from the print sheet with the test pattern formed thereon. The correction processing portion 84 corrects the ink ejection amounts of a part of the plurality of nozzles related to the abnormal ejection nozzle. The correction processing portion 84 corrects the ink ejection amounts of the consecutive adjacent nozzles and the secondary adjacent nozzles when a plurality of abnormal ejection nozzles are detected and the plurality of the abnormal ejection nozzles include two consecutive abnormal nozzles. At this time, the correction processing portion 84 performs increase correction on the ink ejection amount of the consecutive adjacent nozzles and performs decrease correction on the ink ejection amount of the secondary adjacent nozzles.

As a result, even when an ejection abnormality occurs in two consecutive nozzles adjacent to each other in the main scanning direction, a decrease in print image quality caused by an increase in the ink ejection amount of the consecutive adjacent nozzles is suppressed.

The present disclosure can be applied to, for example, an inkjet image forming apparatus.

It is to be understood that the embodiments herein are illustrative and not restrictive, since the scope of the disclosure is defined by the appended claims rather than by the description preceding them, and all changes that fall within metes and bounds of the claims, or equivalence of such metes and bounds thereof are therefore intended to be embraced by the claims.

1. A image forming apparatus comprising:
a sheet conveying portion configured to convey a sheet;
a print head including a plurality of nozzles for forming an image on the conveyed sheet by ejecting ink onto the sheet;
a control portion configured to cause the sheet conveying portion and the print head to execute processing for forming a test pattern on the sheet;
an abnormal ejection detection portion configured to detect an abnormal ejection nozzle in the print head based on a read test image read from the sheet with the test pattern formed thereon; and
a correction processing portion configured to correct an ink ejection amount of a part of the plurality of nozzles corresponding to the abnormal ejection nozzle, wherein
when a plurality of the abnormal ejection nozzles are detected and the plurality of abnormal ejection nozzles include two consecutive abnormal nozzles corresponding to two consecutive pixels in the read test image, the correction processing portion performs increase correction on an ink ejection amount of consecutive adjacent nozzles adjacent to the two consecutive abnormal nozzles and performs decrease correction on an ink ejection amount of secondary adjacent nozzles adjacent to the consecutive adjacent nozzles.

2. The image forming apparatus according to claim 1, wherein when a correction condition based on an ink ejection amount after the increase correction of the consecutive adjacent nozzles and the ink ejection amount before the correction of the secondary adjacent nozzles is satisfied, the correction processing portion performs decrease correction on the ink ejection amount of the secondary adjacent nozzles, and when the correction condition is not satisfied, the correction processing portion does not perform decrease correction on the ink ejection amount of the secondary adjacent nozzles.

3. The image forming apparatus according to claim 1, wherein when the abnormal ejection nozzle includes an isolated abnormal nozzle corresponding to an isolated pixel in the read test image, the correction processing portion performs increase correction on an ink ejection amount of isolated adjacent nozzles adjacent to the isolated abnormal nozzle by an amount smaller than a correction amount of the ink ejection amount of the consecutive adjacent nozzles.
